(19) United States
(12) Patent Application Publication
(10) Pub. No.: US 2006/0256747 A1
(43) Pub. Date: Nov. 16, 2006

(54) Terminal assisted WLAN access point rate adaptation

(76) Inventor: Mikko Jaakkola, Lempaala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/133,657

(22) Filed: May 16, 2005

(51) Int. Cl. H04Q 7/24; H04Q 7/00

(52) U.S. Cl. 370/328; 370/338

(57) ABSTRACT

A method and apparatus are provided for adapting a transmission rate for providing data in a downlink direction from a network element such as an access point (AP) in a wireless network to a terminal, wherein the method features the step of the terminal providing a message to the network element containing information to assist the network element in adapting the communication link, including one or more parameters related to the transmission rate or retransmission retry, in the downlink direction. In operation, the network element receives the message and adapts the communication link in the downlink direction accordingly based on the message.

### BACKGROUND OF THE INVENTION

1. Field of Invention

The present invention related to a method and apparatus for adapting a transmission rate for providing data in a downlink direction from an access point (AP) in a wireless network to a terminal; and more particularly, relates to implementing the same in relation to multimode terminals where a device has multiple radios present with a wireless local area network (WLAN).

2. Description of Related Art

FIG. 1 shows, by way of example, typical parts of an IEEE 802.11 WLAN system, which is known in the art and provides for communications between communications equipment such as mobile and secondary devices including personal digital assistants (PDAs), laptops and printers, etc. The WLAN system may be connected to a wire LAN system that allows wireless devices to access information and files on a file server or other suitable device or connecting to the Internet. The devices can communicate directly with each other in the absence of a base station in a so-called “ad-hoc” network, or they can communicate through a base station, called an access point (AP) in IEEE 802.11 terminology, with distributed services through the AP using local distributed services set (DSS) or wide area extended services (ESS), as shown. In a WLAN system, end user access devices are known as stations (STAs), which are transceivers (transmitters/receivers) that convert radio signals into digital signals that can be routed to and from communications device and connect the communications equipment to access points (APs) that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

FIGS. 2a and 2b show diagrams of the Universal Mobile Telecommunications System (UMTS) packet network architecture, which is also known in the art. In FIG. 2a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 2b shows some further details of the architecture, particularly the UTRAN, which includes multiple Radio Network Subsystems (RNSs), each of which contains at least one Radio Network Controller (RNC).

The interworking of the WLAN (IEEE 802.11) shown in FIG. 1 with such other technologies (e.g. 3GPP, 3GPP2 or 802.16) such as that shown in FIGS. 2a and 2b is being defined at present in protocol specifications for 3GPP and 3GPP2.

One problem with such interworkings in that there are indications that, for example, GSM transmission can reduce the WLAN received sensitivity by −15 dBm causing retransmissions. Periodic packet transmission, e.g. during a GSM voice call, can cause conventional rate algorithms in a WLAN AP to make the situation even worse and cause full blocking of WLAN traffic.

Current measurements show that cellular transmission causes a drop of −15 dBm in the WLAN receiver sensitivity, which then causes the system to not hear packets during those periods. Current WLAN rate-adaptation algorithms usually interpret the lost packets to be a cause of bad noise conditions, which then causes the WLAN AP to drop the transmission rate. This then increases the likelihood of the collision to be even greater (more airtime per packet is spent in the air). In the end, very little data would go through in the system when the signal strength is anything between medium to low as the system would think that the overall noise levels are too bad. The best thing that the system could do in this situation is to retry the packet sending with the same or even higher data rates in order to minimize the chances of the collision with periodic cellular transmissions.

No radio measurement algorithms can really detect from the WLAN AP if there are periodic noise in the terminal side (not visible to an air-interface using WLAN frequencies).

The basic problem is that the WLAN AP does not have any knowledge about the dual(/multi)mode operation at the terminal end and there is no way for it to find out about it unless the terminal explicitly tells its conditions to WLAN AP one way or another.

Moreover, in multiradio devices, it is possible that the activity of other radios can cause degradation in the receiver sensitivity of the STA WLAN. For example, GSM/GPRS TX can cause a drop of 10-20 dBm in a receiver's sensitivity levels, which cannot be measured by any other means; or a vibrating alert or other radios can cause a similar effect.

FIG. 3 shows examples of are two basic interference situations between GSM-WLAN and WLAN-Bluetooth (BT). In the first case, a coexistent radio Tx interferes with a WLAN Rx (e.g. GSM to WLAN). In the second case, a coexistent radio Tx interferes with a WLAN Rx and the WLAN Tx interferes with the coexistent radio Rx (e.g. WLAN to/from BT). If this is known, then the AP can make some assumptions. In the first case, the STA can transmit during the interference burst, where the AP can receive an ACK from the STA during the interference. In the second case, the STA interferes the other radio if it transmits during the interference burst, where the AP may not receive the ACK from the STA during the interference, and the STA may also do some scheduling between radios.

The reader is also referred to Publication No. US2005/0086569 A1, which discloses a collective rate adaptation technique for terminals, wherein the transmission rate is decreased when the transmission has failed a certain number of time.

### SUMMARY OF THE INVENTION

In its broadest sense, the present invention provides a method and apparatus for adapting a communication link for providing data in a downlink direction from a network element such as an access point (AP) in a wireless network to a terminal, wherein the method features the step of receiving a message in the network element from the terminal containing information to assist the network element in adapting the communication link in the downlink direction.

The message may include one or more communication link parameters which may be changed, such as a transmission rate parameter that defines the rate of transmission for the downlink connection, a retry parameter that defines the number of retransmissions applied for the downlink connection, or some combination thereof. For example, in response to a message containing a desired transmission rate being selected by the terminal, the network element can adapt the transmission rate in the downlink direction accordingly based on the message.

In particular, the message may take the form of a terminal rate configuration containing information about a terminal rate configuration being requested by the terminal. Alternatively, the message may take the form of a terminal conditions report containing information about current conditions of the terminal that affect the transmission rate, including an interference situation. In this case, the message may include information about an interference source, and the access point (AP) will receives the message and adapt the transmission rate based on the current conditions of the terminal. Moreover still, the message may take the form of an interference triggered renegotiation so as to reassociate with the network element, or may include information about a terminal specified rate adaptation set, including one or more transmission rates, re-tries, or some combination thereof, specific to the terminal. In such cases, the access point will receive the message and optimizes transmission rate fallback policies so that the overall system can have the best possible performance under current conditions of the terminal. Embodiments are also envisioned in which the message is provided as part of an association process between the network element and the terminal.

The terminal may take the form of a mobile phone, a station (STA) or other suitable user equipment.

The wireless network may take the form of a wireless local area network (WLAN) defined by the IEEE 802 Specification Protocol, or other suitable wireless network either now known or later developed in the future.

In one embodiment, the terminal is a multimode terminal having multiple radios that can operates in a GSM network, although the scope of the invention is not intended to be limited to any particular type of terminal or user equipment either now known or later developed in the future.

The present invention may also take the form of a method having one or more of the aforementioned steps performed in a computer program running on a processor or other suitable processing device in a network node or element in the network or system.

The present invention also includes apparatus that may take the form of an access point (AP) or other suitable network element for receiving the message from the terminal and adapting the communication link based on such a message, as well as a terminal for providing such a message.

The present invention may also take the form of computer program product for such a network node or element including an access point (AP) for adapting a communication link for providing data in a downlink direction from a network element in a wireless network to a terminal, wherein the computer program product adapts the based on information received in a message from the terminal; as well as a computer program product for a terminal for receiving data in communication link in a downlink direction in a wireless network from a network element such as an access point (AP) or other suitable element capable of adapting the communication link, wherein the computer program product provides a message to the network element containing information to assist the network element in adapting the communication link.

The present invention may also take the form of module such as a chip for providing the aforementioned functionality in such a network node or element including an access point (AP) as well as a terminal or other user equipment.

In particular, the present invention sets forth two solutions to the aforementioned interference situations between the GSM-WLAN and WLAN-Bluetooth (BT). The first solution is to use a so-called reason field, where the AP can make some assumptions from the reason field, e.g. an interference source. This is a more general solution and allows adding new interferences. This may also help the AP understand whether it should do some changes for example to the data rate. The second solution is to use a so-called Tx capable field, which is a field that indicates whether the STA Tx is possible during an interference burst.

In effect, the present invention sets forth a new technique that provides more knowledge of the multimode terminal's current conditions by exchanging a message with an WLAN AP in order to allow it to optimize its transmission rate fallback policies so that the overall system can have the best possible performance under the current conditions.

One advantage of the present invention is that terminal related interferences can be communicated to WLAN AP so that the AP can optimize the performance for the whole network in the cases where there are simultaneous WLAN connections during cellular calls. For example, the terminal or station can provide its sensitivity level to the AP, which can indicate better performance than that mandated by the specification, used to fine tune the rate adaptation algorithm of the AP, can indicate sudden changes in the terminal's sensitivity, or can indicate “interference slots

### BRIEF DESCRIPTION OF THE DRAWING

The drawing includes the following Figures, which are not necessarily drawn to scale:

FIG. 1 shows a diagram of a wireless local network (WLAN).

FIGS. 2a and 2b show diagrams of the 3GPP network.

FIG. 3 includes FIGS. 3a and 3b, which show two different know interference cases, one between GSM-WLAN and the other between WLAN-Bluetooth.

FIG. 4 is a block diagram of an access point (AP) according to the present invention.

FIG. 5 is a block diagram of a terminal according to the present invention.

FIG. 6 shows an example of a sensitivity indication frame according to the present invention.

FIG. 7 shows in more detail the field for the interference characteristic of the sensitivity indication field in FIG. 6.

### BEST MODE OF THE INVENTION

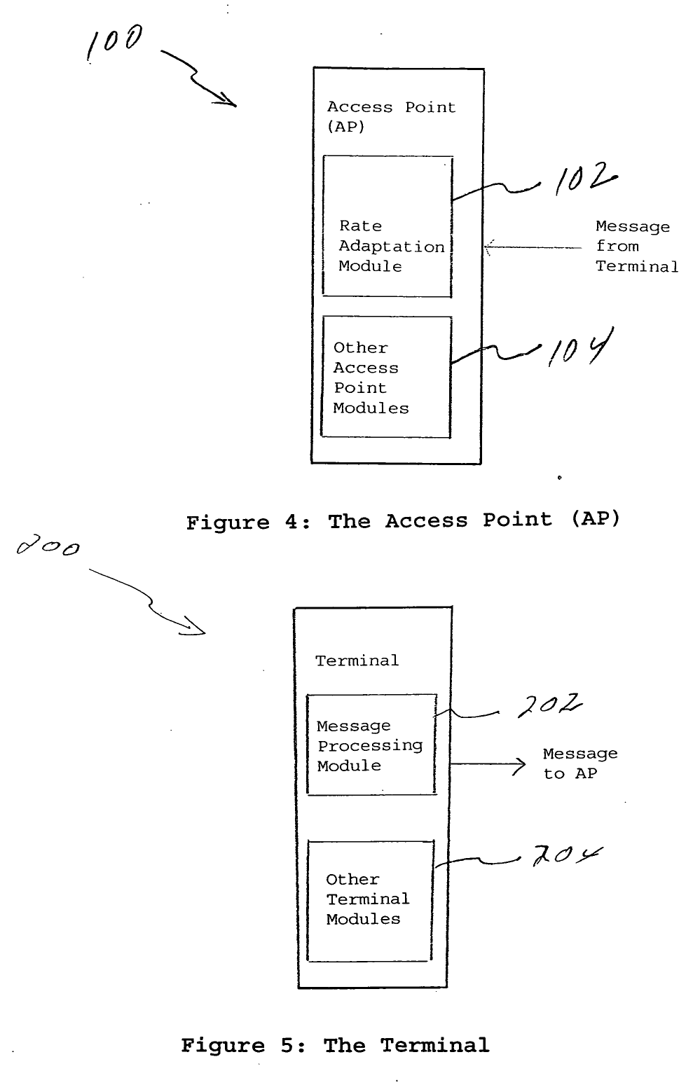

FIG. 4 shows an access point (AP) according to the present invention and generally indicated as 100 for adapting a communication link for providing data in a downlink direction in a wireless network to a terminal shown in FIG. 5, wherein the AP 100 includes a rate adaptation module 102 that receives a message from the terminal 200 containing information to assist the AP 100 in adapting the communication link in the downlink direction, and adapts the communication link based on the information contained in the message, in accordance with the present invention and consistent with that described herein.

The message may include one or more communication link parameters which may be changed, such as a transmission rate parameter that defines the rate of transmission for the downlink connection, or a retry parameter that defines the number of retransmissions applied for the downlink connection, or one or more other suitable communication link parameters either now known or later developed in the future, or some combination thereof. The scope of the invention is not intended to be limited to any particular type or kind of communication link parameter, or the number of such parameters in the massage. Moreover, the scope of the invention is intended to include communication link parameters both now known or later developed in the future.

In particular, the message may contain information about a desired transmission rate being selected by the terminal. For example, the message may contain information about a terminal rate or other suitable configuration being requested by the terminal. The scope of the invention is not intended to be limited to any particular type or kind of configuration either now known or later developed in the future being requested by the terminal.

Alternatively, the message may take the form of a terminal conditions report containing information about current conditions of the terminal that affect the transmission rate, including an interference situation. For example, the interference situation may include interference from a periodic source, like a GSM transceiver in a multimode terminal, or interference from, for example, a microwave oven. In these situations, the message may include information about the interference source, and the access point (AP) will receives the message and adapt the transmission rate based on the current conditions of the terminal. The scope of the invention is not intended to be limited to any particular type or kind of information about the interference source either now known or later developed in the future being reported by the terminal in the message, including interference sources from GSM-type devices, Bluetooth-type device, or other suitable devices.

Moreover still, the message may take the form of an interference triggered renegotiation so as to reassociate with the AP, or may include information about a terminal specified rate adaptation set, including one or more transmission rates, re-tries, or some combination thereof, specific to the terminal. In such cases, the access point will receive the message and optimizes transmission rate fallback policies so that the overall system can have the best possible performance under current conditions of the terminal. Embodiments are also envisioned in which the message is provided as part of an association process between the network element and the terminal.

By way of example, the functionality of the module 102 shown in FIG. 4 may be implemented using hardware, software, firmware, or a combination thereof, although the scope of the invention is not intended to be limited to any particular embodiment thereof. In a typical software implementation, the module 102 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology known or later developed in the future. Moreover, the scope of the invention is intended to include the module 102 being a stand alone module or in the combination with other circuitry for implementing another module.

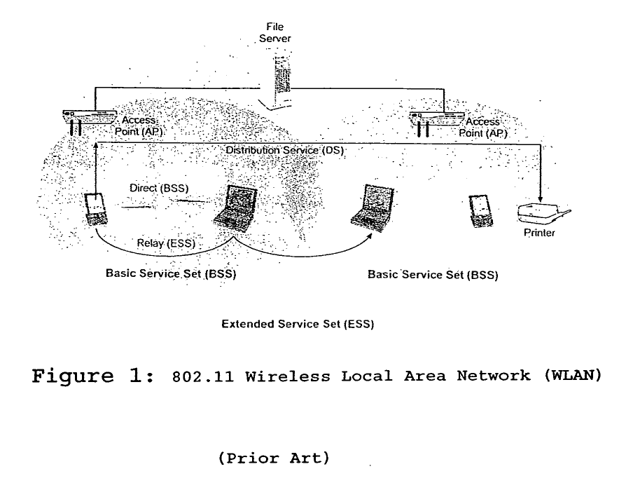

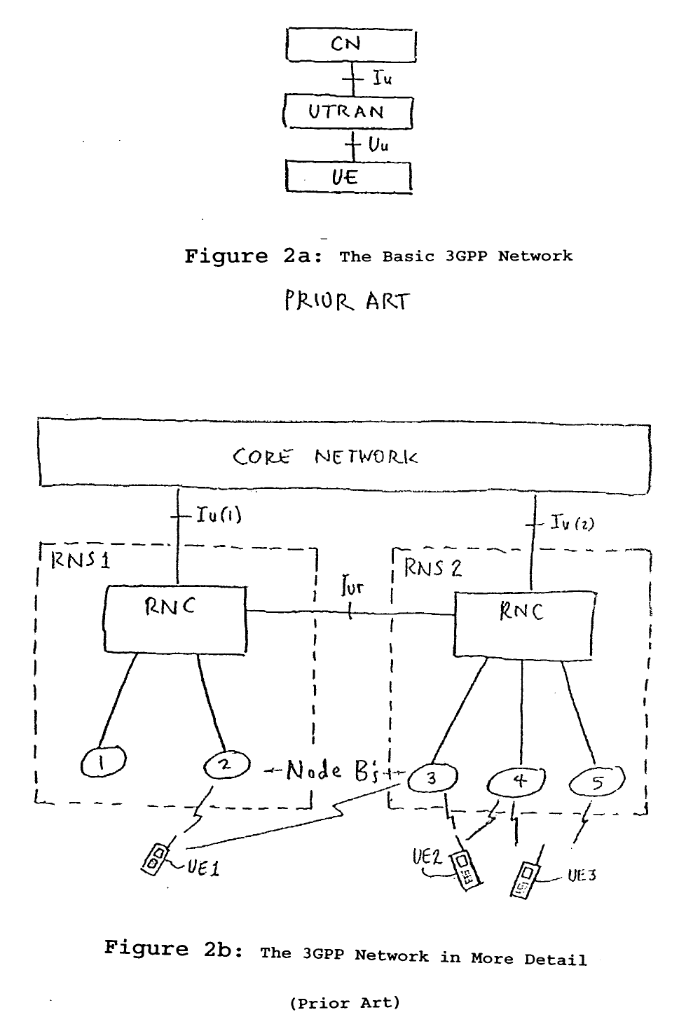

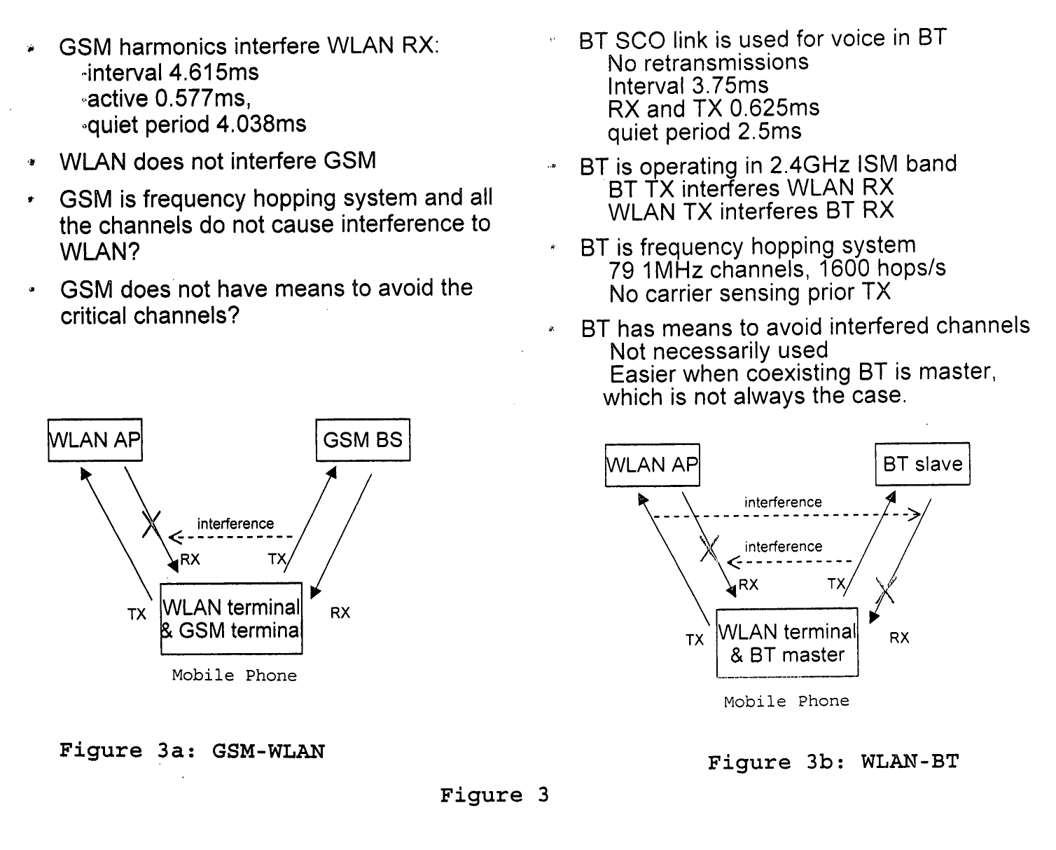

The AP 100 also includes other access point modules 104 that would typically form part of the AP shown, for example, in FIG. 1, for which the functionality thereof is well known in the art, does not form part of the underlying invention per se, and is not described in detail herein.

### The Various Methods

Consistent with that described herein, there are alternative methods that can be used to implement the scheme or technique according to the present invention. The alternatives include a terminal rate configuration request, a terminal conditions report or interference triggered re negotiations. The first two methods require definitions for new messages in a similar manner like the admission control is done for QoS at the current systems. The new message can be either a totally new type of management message or it can be implemented as part of the association process. The configuration via an association frame would imply that the system would have to do re-association at beginning and after every call.

### Terminal Rate Configuration Request

For example, in one method the message may take the form of a special WLAN management message which may be used to ask for the WLAN AP to use a terminal specified rate adaptation set (transmission rates & re-tries per rate values). In practice, when a voice (or data) call is starting, the WLAN subsystem would be notified about the call and would send a request message to the WLAN AP that can then configure its rate adaptation policy for the terminal according to the wishes of the terminal.

### Terminal Conditions Report

Alternatively, the message may take the form of a terminal conditions report which is similar to the first scheme or method with the exception that instead of sending a detailed rate adaptation policy the terminal would send a message (e.g. message saying that periodic interference present) describing the conditions of the terminal and let the WLAN AP to use an appropriate policy (not specified by any standard) to overcome the problems according to general guidelines.

### Interference Triggered Renegotiations

Further, the message may also form part of interference triggered renegotiations. This is the only scheme that could be deployed with the existing equipment known in the art. In this scheme, the terminal would, in the case of starting a cellular phone call, reassociate with the WLAN AP so that it defines only the highest (the highest in this context means the highest workable data rate) data rates to be as supported rates (and of course all the basic rates), which would effectively limit the used fallback rates so that the system would only use the highest rates for the retries. One minor shortcoming of the scheme is that usually the basic rates are configured to be some of the low rates that would basically allow the WLAN AP to use those rates for optional rates for the fallback rates. In this scheme, the system would send packets with the very high rates and with very low rates.

### FIG. 5: The Terminal

FIG. 5 shows, by way of example, a terminal, station (STA) or other suitable user equipment according to the present invention and generally indicated as 200 having a message processing module 202 as well as other station modules 204.

In operation, the message processing module 202 provides the message to the AP 100 containing information to assist the AP 100 in adapting the transmission rate, in accordance with the present invention and consistent with that described herein. The terminal may take the form of a mobile phone, a station (STA) or other suitable user equipment either now known or later developed in the future.

By way of example, the functionality of the module 202 shown in FIG. 5 may be implemented using hardware, software, firmware, or a combination thereof, although the scope of the invention is not intended to be limited to any particular embodiment thereof. In a typical software implementation, the module 202 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology known or later developed in the future. Moreover, the scope of the invention is intended to include the module 202 being a stand alone module or in the combination with other circuitry for implementing another module.

The scope of the invention is also not intended to be limited to implementing the present invention in any particular type or kind of terminal STA or user equipment now known or later developed in the future.

The other station modules 204 and the functionality thereof are known in the art, do not form part of the underlying invention per se, and are not described in detail herein. For example, the station modules 204 may include a module which are known in the art for detecting and evaluating interference from one or more interference sources, and the scope of the invention is not intended to be limited to the type of kind of module for doing the same.

### Example of AP Policy After Interference Detection

The present invention may also form part of a general policy on how the AP can configure for a downlink connection in case of interference. For example, a policy may be such that the AP will not decrease the rate it is applying to the downlink transmission, rather continues transmission with the same rate as before. Furthermore, the policy which is applied may contain also a parameter which defines the number of retransmissions applied for the downlink connection in case such are needed due to erroneous transmissions. In operation, the message may include one or more communication link parameters which may be changed; and the one or more communication link parameters may include a transmission rate parameter that defines the rate of transmission for the downlink connection, or a retry parameter that defines the number of retransmissions applied for the downlink connection, one or more other suitable communication link parameters either now known or later developed in the future, or some combination of such parameters.

### Advantages

One advantage of the present invention is that due to higher transmission rates air time is not consumed as much as with lower data rates. An important factor in minimizing air time is that the payload of the MPDUs which are sent to the air, is not too small, because the air time will in such a case be mostly consumed by the header fields of the frame. Therefore, it appears favorable that the AP can also have a parameter about sending more data in a single MPDU (in addition to retry and rate parameters). This results in less time spent in accessing the channel as more is sent.

### The STA Sensitivity Indication Frame

By way of example, the present invention may be implemented in an STA sensitivity indication frame generally indicated as 300 and shown in FIG. 6 that is a new management frame which may contain the STA current noise floor, the STA TX power and the position of the interference in time, which can include information about interference, for example, from a periodic interference source like a GSM transceiver in a multimode case, or from a microwave oven in an external interference case, consistent with that set forth below.

The frame fields may include the following:

1) The STA noise floor 302,

2) The STA TX power 304,

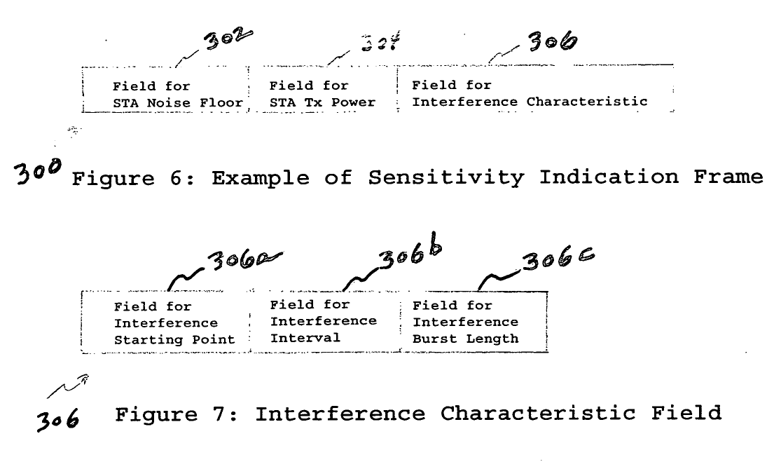

3) The interference characteristics 306 shown in FIG. 7, including
a) ‘Interference’ starting point (TSF) 306a, which is starting point of next ‘interference’ bursts.
b) ‘Interference’ interval 306b, which is the interval between two successive ‘interference’ bursts. For example, in case of GSM TX this is 4,038 ms.
c) ‘Interference’ burst length 306c, which in the case of GSM TX this is 0.577 ms.

If the position and/or periodicity of interference is not known, or the STA is using the frame to indicate better sensitivity than specified in the standard, the STA can set these values to ‘0’.

### Usage of STA Sensitivity Information

The STA sensitivity information may be used, as follows:

1) If the interference characteristic fields are set to ‘0’, then it can be used directly for e.g. rate adaptation purposes.

2) Alternatively, if the interference characteristic fields are ‘0’, then the AP can:
a) Keep the rate the same (even if there are lost frames) and try to avoid ‘Interference’ slots; or
b) Use a more robust rate.

3) In interference does not exist anymore, the STA can update its sensitivity information by sending the frame with interference characteristic fields set to ‘0’.

### STA Sensitivity Information Frame Conclusion

The STA sensitivity information provides valuable information for the AP:
1) The STA can indicate that its sensitivity is better than that mandated by the specifications, for example, for use as a direct input for APs rate adaptation logic.
2) The STA can indicate that its sensitivity is degraded. In this case, the STA can specify interference characteristic, and/or the AP can avoid ‘interference’ slots.

### Other Considerations

Other considerations include the following:

In operation, the new proprietary messages can be easily spotted by using a device, such as WLAN sniffers, that can capture WLAN traffic.

### SCOPE OF THE INVENTION

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What I claim is:

1. A method for adapting a communication link for providing data in a downlink direction from a network element in a wireless network to a terminal, characterized in that the method comprises the step of:
the network element receiving a message from the terminal containing information to assist the network element in adapting the communication link in the downlink direction.

2. A method according to claim 1, wherein the network element adapts the transmission rate of the communication link accordingly based on the message.

3. A method according to claim 1, wherein the message contains information about the supported rates by the terminal, or a desired transmission rate being selected by the terminal.

4. A method according to claim 1, wherein the message is a terminal rate configuration containing information about a terminal rate configuration being requested by the terminal.

5. A method according to claim 1, wherein the message is a terminal conditions report containing information about current conditions of the terminal that affect the transmission rate, including an interference situation.

6. A method according to claim 4, wherein the message includes information about an interference source.

7. A method according to claim 4, wherein the network element is an access point (AP) that receives the message and adapts the transmission rate based on the current conditions of the terminal.

8. A method according to claim 1, wherein the message is an interference triggered renegotiation so as to reassociate with the network element.

9. A method according to claim 1, wherein the message includes information about a terminal specified rate adaptation set, including one or more transmission rates, re-tries, or some combination thereof, specific to the terminal.

10. A method according to claim 1, wherein the network element receives the message and optimizes transmission rate fallback policies so that the overall system can have the best possible performance under current conditions of the terminal.

11. A method according to claim 1, wherein the wireless network is a wireless local area network (WLAN) defined by the IEEE 802 Specification Protocol.

12. A method according to claim 1, wherein the terminal is a multimode terminal having multiple radios that can operates in a GSM network.

13. A method according to claim 12, wherein the multimode terminal has multiple radios.

14. A method according to claim 1, wherein the message is provided as part of an association process between the network element and the terminal.

15. An access point (AP) for adapting a communication link for providing data in a downlink direction in a wireless network to a terminal, characterized in that
the AP receives a message from the terminal containing information to assist the AP in adapting the communication link in the downlink direction.

16. An access point (AP) according to claim 15, wherein the AP adapts the transmission rate of the communication link based on the information contained in the message.

17. An access point (AP) according to claim 15, wherein the message contains information about the supported rates by the terminal, or a desired transmission rate being selected by the terminal.

18. An access point (AP) according to claim 15, wherein the message is a terminal rate configuration containing information about a terminal rate configuration being requested by the terminal.

19. An access point (AP) according to claim 15, wherein the message is a terminal conditions report containing information about current conditions of the terminal that affect the transmission rate, including an interference situation.

20. An access point (AP) according to claim 19, wherein the message includes information about an interference source.

21. An access point (AP) according to claim 19, wherein the network element receives the message and adapts the transmission rate based on the current conditions of the terminal.

22. An access point (AP) according to claim 15, wherein the message is an interference triggered renegotiation so as to reassociate with the network element.

23. An access point (AP) according to claim 15, wherein the message includes information about a terminal specified rate adaptation set, including one or more transmission rates, re-tries, or some combination thereof, specific to the terminal.

24. An access point (AP) according to claim 15, wherein the network element receives the message and optimizes transmission rate fallback policies so that the overall system can have the best possible performance under current conditions of the terminal.

25. An access point (AP) according to claim 15, wherein the wireless network is a wireless local area network (WLAN) defined by the IEEE 802 Specification Protocol.

26. An access point (AP) according to claim 15, wherein the terminal is a multimode terminal having multiple radios that can operates in a GSM network.

27. An access point (AP) according to claim 15, wherein the terminal is a multimode terminal that can operates in a GSM network.

28. An access point (AP) according to claim 15, wherein the message is provided as part of an association process between the network element and the terminal.

29. A terminal for receiving data in a communication link in a downlink direction in a wireless network from a network element such as an access point (AP) or other suitable element capable of adapting the transmission rate, characterized in that
the terminal provides a message to the network element containing information to assist the network element in adapting the communication link in the downlink direction.

30. A terminal according to claim 29, wherein the message contains information about the supported rates in the communication link by the terminal, or about a desired transmission rate in the communication link being selected by the terminal.

31. A terminal according to claim 29, wherein the message is a terminal rate configuration containing information about a terminal rate configuration being requested by the terminal.

32. A terminal according to claim 29, wherein the message is a terminal conditions report containing information about current conditions of the terminal that affect the transmission rate, including an interference situation.

33. A terminal according to claim 32, wherein the message includes information about an interference source.

34. A terminal according to claim 29, wherein the message is an interference triggered renegotiation so as to reassociate with the network element.

35. A terminal according to claim 29, wherein the message includes information about a terminal specified rate adaptation set, including one or more transmission rates, re-tries, or some combination thereof, specific to the terminal.

36. A terminal according to claim 29, wherein the information in the message enables the network element to optimize transmission rate fallback policies so that the overall system can have the best possible performance under current conditions of the terminal.

37. A terminal according to claim 29, wherein the wireless network is a wireless local area network (WLAN) defined by the IEEE 802 Specification Protocol.

38. A terminal according to claim 29, wherein the terminal is a multimode terminal having multiple radios that can operates in a GSM network.

39. A terminal according to claim 38, wherein the multimode terminal has multiple radios.

40. A terminal according to claim 29, wherein the message is provided as part of an association process between the network element and the terminal.

41. A method according to one or more of claims 1-14, wherein the one or more steps of the method are performed in a computer program running on a processor or other suitable processing device in a network node or element in the network or system.

42. A method according to claim 41, wherein the network node or element is an access point in a wireless network.

43. A method according to claim 41, wherein the network node or element is a multimode terminal having multiple radios that can operates in a GSM network.

44. A computer program product for a network node or element such as an access point (AP) for adapting a communication link for providing data in a downlink direction from a network element in a wireless network to a terminal, characterised in that
the computer program product adapts the communication link in the downlink direction based on information received in a message from the terminal.

45. A computer program product for a terminal for receiving data in a communication link in a downlink direction in a wireless network from a network element such as an access point (AP) or other suitable element capable of adapting the transmission rate, characterized in that
the computer program product provides a message to the network element containing information to assist the network element in adapting the communication link in the downlink direction.

46. A module such as a chip for a network node or element such as an access point (AP) for adapting a communication link for providing data in a downlink direction from a network element in a wireless network to a terminal, characterised in that
the module adapts the communication link in the downlink direction based on information received in a message from the terminal.

47. A module such as a chip for a terminal for receiving data in a communication link in a downlink direction in a wireless network from a network element such as an access point (AP) or other suitable element capable of adapting the communication link, characterized in that
the module provides a message to the network element containing information to assist the network element in adapting the communication link in the downlink direction.

48. A method according to claim 1, wherein the message includes a sensitivity indication frame having a field containing information about the noise floor, Tx power, one or more interference characteristics, or some combination thereof.

49. A method according to claim 48, wherein the field for the one or more interference characteristics includes a field containing information about an interference starting point, an interference level, an interference burst length, or some combination thereof.

50. An access point (AP) according to claim 15, wherein the message includes a sensitivity indication frame having a field containing information about the noise floor, Tx power, one or more interference characteristics, or some combination thereof.

51. An access point (AP) according to claim 50, wherein the field for the one or more interference characteristics includes a field containing information about an interference starting point, an interference level, an interference burst length, or some combination thereof.

52. A terminal according to claim 29, wherein the message includes a sensitivity indication frame having a field containing information about the noise floor, Tx power, one or more interference characteristics, or some combination thereof.

53. A terminal according to claim 52, wherein the field for the one or more interference characteristics includes a field containing information about an interference starting point, an interference level, an interference burst length, or some combination thereof.

54. A method according to claim 1, wherein the message includes one or more communication link parameters which may be changed.

55. A method according to claim 54, wherein the one or more communications link parameters include a transmission rate parameter that defines the rate of transmission for the downlink connection.

56. A method according to claim 54, wherein the one or more communications link parameters include a retry parameter that defines the number of retransmissions applied for the downlink connection.

57. An access point (AP) according to claim 15, wherein the message includes one or more communication link parameters which may be changed.

58. An access point (AP) according to claims 57, wherein the one or more communication link parameters include a transmission rate parameter that defines the rate of transmission for the downlink connection.

59. An access point (AP) according to claim 57, wherein the one or more communication link parameters include a retry parameter that defines the number of retransmissions applied for the downlink connection.

60. A terminal according to claim 29, wherein the message includes one or more communication link parameters which may be changed.

61. A terminal according to claims 60, wherein the one or more communication link parameters include
a transmission rate parameter that defines the rate of transmission for the downlink connection.

62. A terminal according to claim 60, wherein the one or more communication link parameters include a retry parameter that defines the number of retransmissions applied for the downlink connection.

63. A computer program product according to claim 44, wherein the message includes one or more communication link parameters which may be changed.

64. A computer program product according to claims 63, wherein the one or more communication link parameters include a transmission rate parameter that defines the rate of transmission for the downlink connection.

65. A computer program product according to claim 63, wherein the one or more communication link parameters include a retry parameter that defines the number of retransmissions applied for the downlink connection.

66. A computer program product according to claim 45, wherein the message includes one or more communication link parameters which may be changed.

67. A computer program product according to claims 66, wherein the one or more communication link parameters include a transmission rate parameter that defines the rate of transmissions for the downlink connection.

68. A computer program product according to claim 66, wherein the one or more communication link parameters include a retry parameter that defines the number of retransmissions applied for the downlink connection.

69. A module according to claim 46, wherein the message includes one or more communication link parameters which may be changed.

70. A module according to claims 69, wherein the one or more communication link parameters include
a transmission rate parameter that defines the rate of transmissions for the downlink connection.

71. A module according to claim 69, wherein the one or more communication link parameters include a retry parameter that defines the number of retransmissions applied for the downlink connection.

72. A module according to claim 47, wherein the message includes one or more communication link parameters which may be changed.

73. A module according to claims 72, wherein the one or more communication link parameters include
a transmission rate parameter that defines the rate of transmissions for the downlink connection.

74. A module according to claim 72, wherein the one or more communication link parameters include a retry parameter that defines the number of retransmissions applied for the downlink connection.
